(19) United States
(12) Patent Application Publication
(10) Pub. No.: US 2008/0030915 A1
(43) Pub. Date: Feb. 7, 2008

(54) System and method for conditioning disk drives using a magnetic tunnel

(76) Inventors: Kirk B. Price, San Jose, CA (US); Taeyong Yoon, San Jose, CA (US)

Correspondence Address: WAGNER, MURABITO & HAO LLP, Third Floor, Two North Market Street, San Jose, CA, 95113, US

(21) Appl. No.: 11/499,185

(22) Filed: Aug. 3, 2006

(51) Int. Cl. H02H 1/00; G11B 5/03

(52) U.S. Cl. 361/134; 360/66

(57) ABSTRACT

A magnetic disk conditioner is provided. The disk conditioner comprises a tunnel having a top inside surface and a bottom inside surface. A first array of magnets of alternating polarity is coupled to the top inside surface, the first array of magnets comprising a first portion of reduced field strength. The tunnel further comprises a second array of magnets of alternating polarity coupled to the bottom inside surface, the second array of magnets comprising a second portion of reduced field strength and separated from the first array of magnets by a distance that allows a plurality of disks to simultaneously pass through the tunnel for conditioning.

### TECHNICAL FIELD

This invention relates to the field of hard disk drives, and more particularly to a method for providing a bulk erase tool comprising a magnetic tunnel.

### BACKGROUND ART

Hard disk drives are used in almost all computer system operations. In fact, most computing systems are not operational without some type of hard disk drive to store the most basic computing information such as the boot operation, the operating system, the applications, and the like. In general, the hard disk drive is a device which may or may not be removable, but without which the computing system will generally not operate.

The basic hard disk drive model includes a storage disk or hard disk that spins at a designed rotational speed. An actuator arm is utilized to reach out over the disk. The arm carries a head assembly that has a magnetic read/write transducer or head for reading/writing information to or from a location on the disk. The transducer is attached to a slider, such as an air-bearing slider, which is supported adjacent to the data surface of the disk by a cushion of air generated by the rotating disk. The transducer can also be attached to a contact-recording type slider. In either case, the slider is connected to the actuator arm by means of a suspension. The complete head assembly, e.g., the suspension and head, is called a head gimbal assembly (HGA).

In operation, the hard disk is rotated at a set speed via a spindle motor assembly having a central drive hub. Additionally, there are tracks evenly spaced at known intervals across the disk. When a request for a read of a specific portion or track is received, the hard disk aligns the head, via the arm, over the specific track location and the head reads the information from the disk. In the same manner, when a request for a write of a specific portion or track is received, the hard disk aligns the head, via the arm, over the specific track location and the head writes the information to the disk.

Over the years, the disk and the head have undergone great reductions in their size. Much of the refinement has been driven by consumer demand for smaller and more portable hard drives such as those used in personal digital assistants (PDAs), MP3 players, and the like. For example, the original hard disk drive had a disk diameter of 24 inches. Modem hard disk drives are much smaller and include disk diameters of less than 2.5 inches (micro drives are significantly smaller than that). Advances in magnetic recording are also primary reasons for the reduction in size.

This continual reduction in size has placed steadily increasing demands on the technology used in the HGA, particularly in terms of power consumption, shock performance, and disk real estate utilization. One recent advance in technology has been the development of the Femto slider, which is roughly one-third of the size and mass of the older Pico slider, which it replaces; over the past 23 years, slider size has been reduced by a factor of five, and mass by a factor of nearly 100.

These smaller sliders have substantially smaller surface areas, which increases the difficulties associated with achieving and maintaining a suitable fly height. Additionally, several of the applications for Femto sliders call for smaller disks, to better fit in portable electronic devices, and lower rotational speeds, to better conserve power. Moreover, with reduced flying heights, contact between the slider and disk surface becomes unavoidable. Coupled with concerns for slider damping in and out of contact with the disk surface, it has proven very difficult to find an appropriate design for the air bearing surface that meets the needs imposed by current demand.

After assembling the mechanical components to form the hard disk drive, servo patterns are written on the new disks to prepare the hard disk drives for customer use. However, the surface of the disk must be conditioned or magnetically cleaned prior to writing the servo patterns.

Generally, a magnetic erase tool is used to erase the magnetic patterns on the disk of a hard disk drive prior to writing the servo (e.g. timing) tracks on the disks. Conventional magnetic disk conditioners can only process a single disk at a time. Furthermore, conventional disk conditioners apply a static magnetic field which does not completely “clean” the disk of magnetic patterns.

### SUMMARY

A magnetic disk conditioner is provided. The disk conditioner comprises a tunnel having a top inside surface and a bottom inside surface. A first array of magnets of alternating polarity is coupled to the top inside surface, the first array of magnets comprising a first portion of reduced field strength. The tunnel further comprises a second array of magnets of alternating polarity coupled to the bottom inside surface, the second array of magnets comprising a second portion of reduced field strength and separated from the first array of magnets by a distance that allows a plurality of disks to simultaneously pass through the tunnel for conditioning. In one embodiment of the invention, the plurality of disks is passed from a first end of the tunnel to the second end of the tunnel wherein the second end of the tunnel comprises the first and second portions of reduced field strength. In doing so, the disks are magnetically cleaned and conditioned.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a plan view of an HDD with cover and top magnet removed in accordance with one embodiment of the present invention.

FIG. 2 is an exemplary illustration of a disk having magnetic patterns prior to being conditioned in accordance with an embodiment of the present invention.

FIG. 3 is a side view of an exemplary disk conditioner comprising arrays of magnets with alternating polarity and a portion of reduced magnetic field strength in accordance with embodiments of the present invention.

FIG. 4 is an exemplary graph of magnetic characteristics of a disk while being conditioned in accordance with embodiments of the present invention.

FIG. 5 is a side view of an exemplary disk conditioner comprising offset arrays of magnets with alternating polarity and a portion of reduced magnetic field strength in accordance with embodiments of the present invention.

FIG. 6 is an illustration of an exemplary cartridge comprising a plurality of disk drive disks in accordance with embodiments of the present invention.

FIG. 7 is a flowchart of a method for magnetically conditioning a plurality of disks in accordance with one embodiment of the present invention.

FIG. 8 is a flowchart of a method for magnetically conditioning a cartridge comprising a plurality of disks in accordance with one embodiment of the present invention.

### BEST MODES FOR CARRYING OUT THE INVENTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, and components have not been described in detail as not to unnecessarily obscure aspects of the present invention.

Embodiments of the present invention include a magnetic disk conditioner for magnetically “cleaning” or conditioning disk drive disks prior to writing servo tracks. In one embodiment of the invention, magnetically cleaning a disk randomizes magnetism across the surface of the disk. However, it is appreciated that cleaning can be any arranging or patterning of magnetism on the disk.

In one embodiment of the invention, the disk conditioner comprises a tunnel having a top inside surface and a bottom inside surface. A first array of magnets of alternating polarity is coupled to the top inside surface. In one embodiment of the invention, the first array of magnets comprises a first portion of reduced field strength. The tunnel further comprises a second array of magnets of alternating polarity coupled to the bottom inside surface, the second array of magnets also comprising a second portion of reduced field strength and separated from the first array of magnets by a distance that allows a plurality of disks to simultaneously pass through the tunnel for conditioning. In one embodiment of the invention, the plurality of disks is passed from a first end of the tunnel to the second end of the tunnel wherein the second end of the tunnel comprises the first and second portions of reduced field strength. In doing so, the disks are magnetically cleaned and conditioned.

Embodiments of the present invention include a disk conditioner that uses a tunnel with an array of magnets to generate an alternating and gradually decreasing magnetic field to enhance erase effectiveness. Furthermore, the tunnel disk conditioner of the present invention can process a plurality of disks simultaneously, which is an improvement over conventional disk conditioners that can only process a single disk at a time.

In one embodiment of the invention, as a box (e.g., cartridge) passes through the disk conditioner, the magnetism of the magnetic grains of the disk are exposed to the alternating and gradually diminishing magnetic field which makes the magnetism of the magnetic grains randomly distributed and become zero-remanance state.

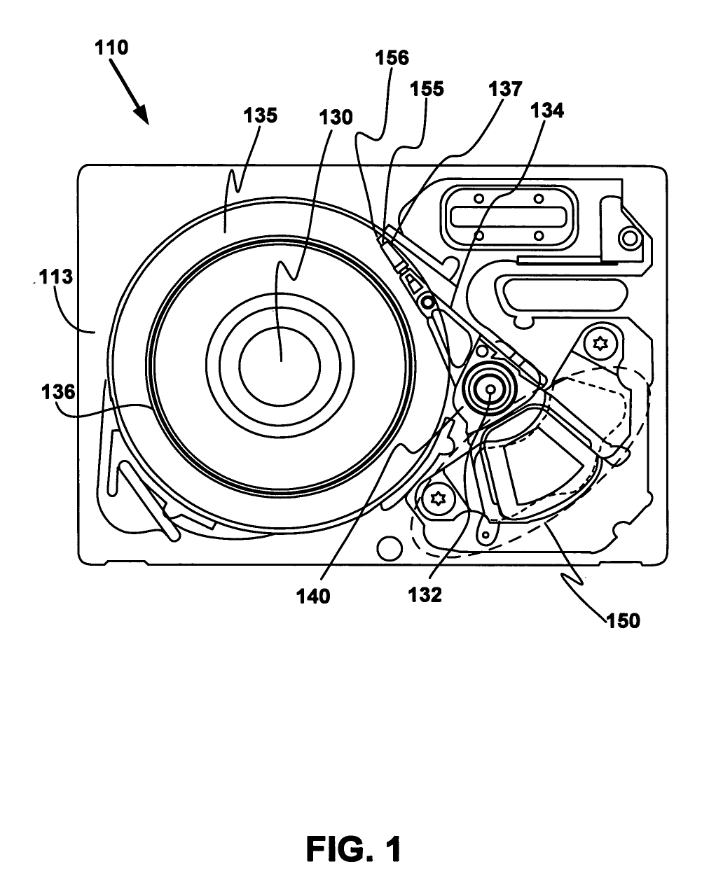

With reference now to FIG. 1, a plan view of an HDD with cover and top magnet removed is shown in accordance with one embodiment of the present invention. FIG. 1 illustrates the relationship of components and sub-assemblies of HDD 110 and a representation of data tracks 136 recorded on the disk surfaces 135 (one shown). The cover is removed and not shown so that the inside of HDD 110 is visible. The components are assembled into base casting 113, which provides attachment and registration points for components and sub-assemblies.

A plurality of suspension assemblies 137 (one shown) are attached to the actuator arms 134 (one shown) in the form of a comb. A plurality of transducer heads or sliders 155 (one shown) are attached respectively to the suspension assemblies 137. Sliders 155 are located proximate to the disk surfaces 135 for reading and writing data with magnetic heads 156 (one shown). The rotary voice coil motor 150 rotates actuator arms 134 about the actuator shaft 132 in order to move the suspension assemblies 150 to the desired radial position on disks 112. The actuator shaft 132, hub 140, actuator arms 134, and voice coil motor 150 may be referred to collectively as a rotary actuator assembly.

Data is recorded onto disk surfaces 135 in a pattern of concentric rings known as data tracks 136. Disk surface 135 is spun at high speed by means of a motor-hub assembly 130. Data tracks 136 are recorded onto spinning disk surfaces 135 by means of magnetic heads 156, which typically reside at the end of sliders 155. FIG. 1 being a plan view shows only one head, slider, and disk surface combination. One skilled in the art understands that what is described for one head-disk combination applies to multiple head-disk combinations, such as disk stacks (not shown). However, for purposes of brevity and clarity, FIG. 1 only shows one head and one disk surface.

The dynamic performance of HDD 110 is a major mechanical factor for achieving higher data capacity as well as for manipulating this data faster. The quantity of data tracks 136 recorded on disk surfaces 135 is determined partly by how well a particular magnetic head 156 and a particular desired data track 136 can be positioned to each other and made to follow each other in a stable and controlled manner.

There are many factors that will influence the ability of HDD 110 to perform the function of positioning a particular magnetic head 156, and following a particular data track 136 with the particular magnetic head 156. In general, these factors can be put into two categories; those factors that influence the motion of magnetic heads 156; and those factors that influence the motion of data tracks 136. Undesirable motions can come about through unwanted vibration and undesirable tolerances of components. Herein, attention is given to construction of sliders 130 and features that contribute to passive damping both in and out of contact with disk surfaces 135. In addition, the disk surface 135 must be magnetically cleaned prior to writing the servo and data tracks. Embodiments of the present invention provide a system and method for magnetically cleaning a plurality of disks simultaneously.

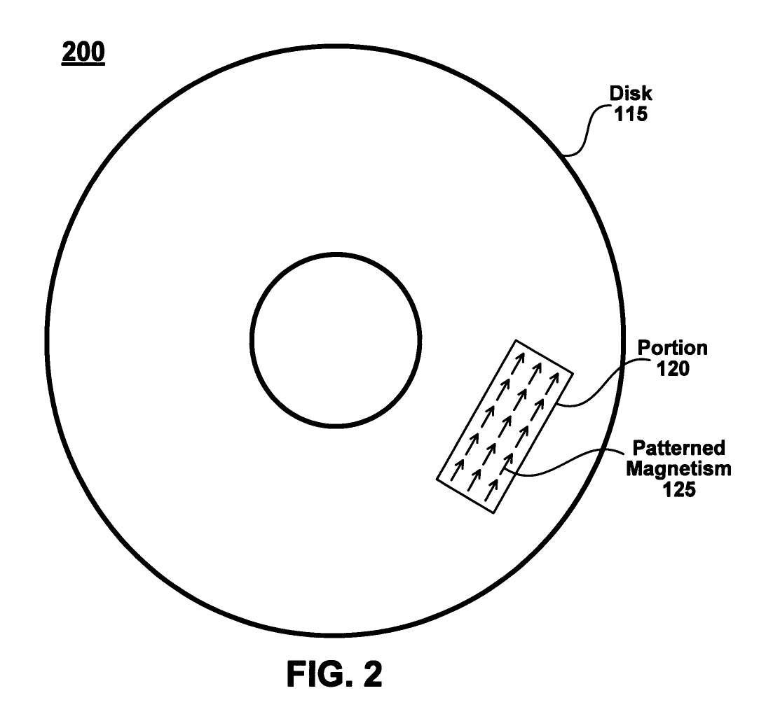

With reference now to FIG. 2, an exemplary diagram 200 of a disk 115 having a portion 120 with patterned magnetism 125 is shown in accordance with one embodiment of the present invention. FIG. 2 is shown to illustrate one embodiment of data (e.g., patterned magnetism 125) to be erased by the disk conditioner tool of the present invention. In one embodiment of the invention, the disk conditioner rearranges the patterned magnetism 125 to a random pattern as opposed to the directional pattern illustrated in FIG. 2.

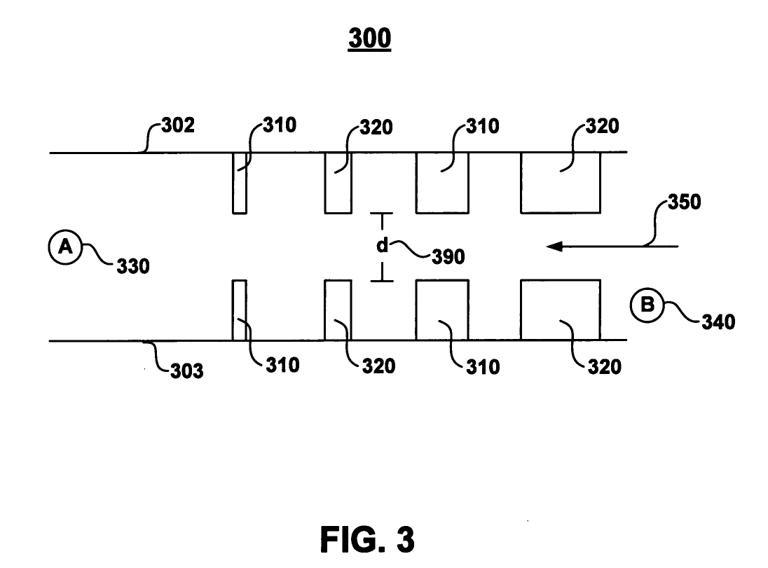

FIG. 3 is a side view of an exemplary disk conditioner 300 comprising arrays of magnets with alternating polarity and a portion of reduced magnetic field strength in accordance with embodiments of the present invention. Disk conditioner 300 comprises a tunnel with a top inside surface 302 and a bottom inside surface 303. A first array of magnets is positioned on the top inside surface 302 of the tunnel and a second array of magnets is positioned on the bottom inside surface 303 of the tunnel. In one embodiment of the invention, the top array of magnets is separated from the bottom array of magnets by a distance (d) 390. In one embodiment of the invention, distance (d) 390 is large enough to accommodate a cartridge comprising a plurality of disks.

In one embodiment of the invention, the top and bottom magnet arrays comprise magnets of alternating polarity. For example, the top array of magnets comprises alternating magnets of polarity 320 and 310. The same is true for the bottom array of magnets as well. In one embodiment of the invention, the size of the magnets is reduced from the first end of the tunnel (b) 340 to the second end (a) 330 of the tunnel. In one embodiment of the invention, the magnetic force within the tunnel is gradually reduced from the first end (b) 340 to the second end (a) 330.

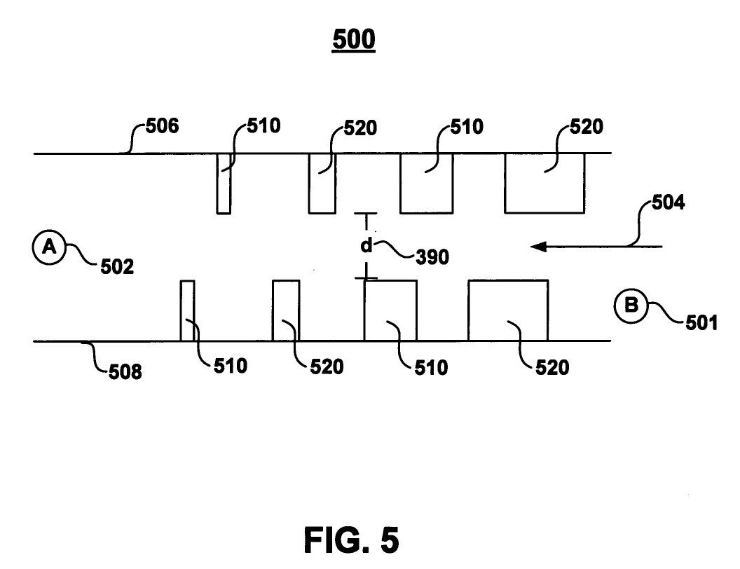

In one embodiment of the invention, the magnets are electromagnets in this embodiment of the invention, the magnetic field of the magnets is reduced from the first end of the tunnel (b) 340 to the second end (a) 330 of the tunnel and could be controlled by a computer system, for example. In one embodiment of the invention, a magnet of a first polarity type (e.g., 320) on the upper inside surface 302 is coincident with a magnet of the same polarity type (e.g., 320) on the bottom inside surface 303. In another embodiment of the invention, magnets of the same polarity type are offset (as illustrated in FIG. 5).

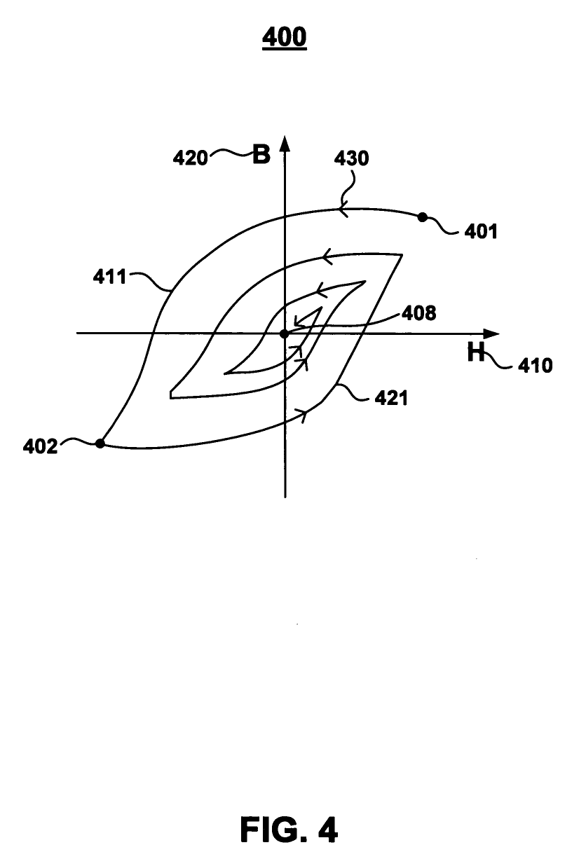

FIG. 4 is an exemplary B-H graph 400 illustrating magnetic characteristics of a disk (or magnetic grain of a disk) while being conditioned in accordance with embodiments of the present invention.

Graph 400 plots the cycling of a magnet grain of a disk as it is saturated at point 401, demagnetized at point 411, saturated in the opposite direction at point 402, and then demagnetized again at point 421 under the influence of the disk conditioner of the present invention. For example, as a disk passes under a magnet of a first polarity type, the disk is magnetically saturated (e.g., at point 401) with the first polarity type. Then as the disk passes towards the opposite polarity type (since the magnet arrays of the disk conditioner comprise magnets of alternating polarity), the disk becomes demagnetized (e.g., at point 411). As the disk passes under the magnet of a second polarity type (e.g., opposite the first polarity type), the disk is magnetically saturated (e.g., at point 401) with the second polarity type. Then as the disk passes towards another magnet of the first polarity type the disk becomes demagnetized (e.g., at point 421).

In one embodiment of the invention, since the magnetic strength of the magnets decreases from a first end of the disk conditioner to the opposite end of the disk conditioner, the magnetism of the disk also decreases as the disk is passed through the conditioner. The results of this are illustrated in B-H graph 400. The arrows 430 show the direction of movement of the disk through the disk conditioner. At the starting point 401, the disk is saturated and the magnetic strength is large. However, as the disk goes through the conditioner, the magnetic strength of the disk diminishes at point 408. In one embodiment of the invention point as a disk reaches point 408, it is at a zero-remanance state and the magnetism of the grains of the disk is randomized. At this point, the disk is ready to have servo patterns written.

FIG. 5 is a side view of an exemplary disk conditioner 500 comprising offset arrays of magnets with alternating polarity and a portion of reduced magnetic field strength in accordance with embodiments of the present invention. Disk conditioner 500 comprises a tunnel with a top inside surface 506 and a bottom inside surface 508. A first array of magnets is positioned on the top inside surface 503 of the tunnel and a second array of magnets is positioned on the bottom inside surface 508 of the tunnel. In one embodiment of the invention, the top array of magnets is separated from the bottom array of magnets by a distance (d) 390. In one embodiment of the invention, distance (d) 390 is large enough to accommodate a cartridge comprising a plurality of disks.

In one embodiment of the invention, the top and bottom magnet arrays comprise magnets of alternating polarity. For example, the top array of magnets comprises alternating magnets of polarity 520 and 510. The same is true for the bottom array of magnets as well. In one embodiment of the invention, the size of the magnets is reduced from the first end of the tunnel (b) 501 to the second end (a) 502 of the tunnel. In one embodiment of the invention, the magnetic force within the tunnel is gradually reduced from the first end (b) 504 to the second end (a) 502. In this embodiment of the invention, magnets of the same polarity type are offset. For example, a magnet of type 520 on the top inside surface 506 is offset from a corresponding magnet of the same type on the bottom inside surface 508.

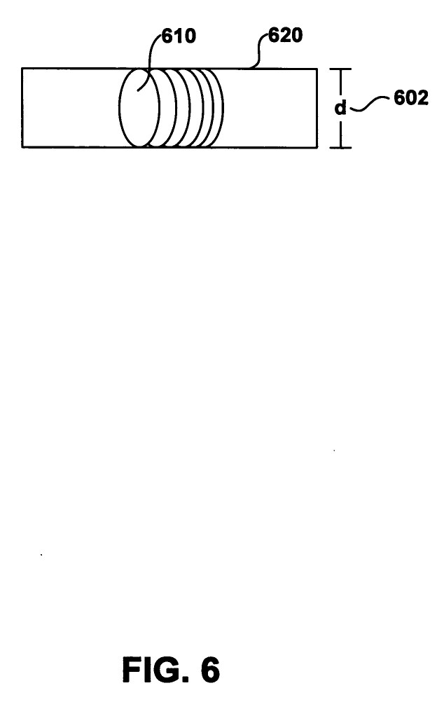

FIG. 6 is an illustration of an exemplary cartridge 620 comprising a plurality of disk drive disks 610 in accordance with embodiments of the present invention. The disk cartridge comprises height of distance (d) 602 which is smaller than distance (d) 390 of FIGS. 3 and 5. In one embodiment of the invention, a plurality of disks are simultaneously conditioned.

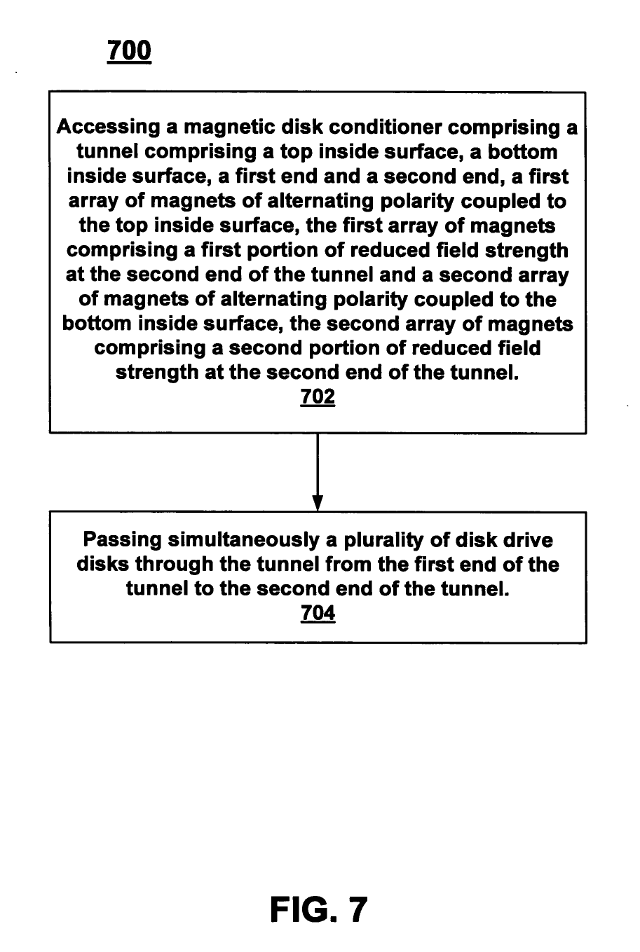

FIG. 7 is a flowchart of a method 700 for magnetically conditioning a plurality of disks in accordance with one embodiment of the present invention. At step 702, method 700 includes accessing a magnetic disk conditioner comprising a tunnel comprising a top inside surface, a bottom inside surface, a first end and a second end, a first array of magnets of alternating polarity coupled to the top inside surface. In one embodiment of the invention, the first array of magnets comprises a first portion of reduced field strength at the second end of the tunnel and a second array of magnets of alternating polarity coupled to the bottom inside surface. The second array of magnets also comprises a second portion of reduced field strength at the second end of the tunnel.

At step 704, method 700 includes passing simultaneously a plurality of disk drive disks through the tunnel from the first end of the tunnel to the second end of the tunnel. In one embodiment of the invention, the first array of magnets and/or the second array of magnets comprises larger magnets at one end of the tunnel and smaller magnets at the other end of the tunnel. In one embodiment of the invention, the sizes of the magnets are graduated from one end to the other. In one embodiment of the magnets are electromagnets.

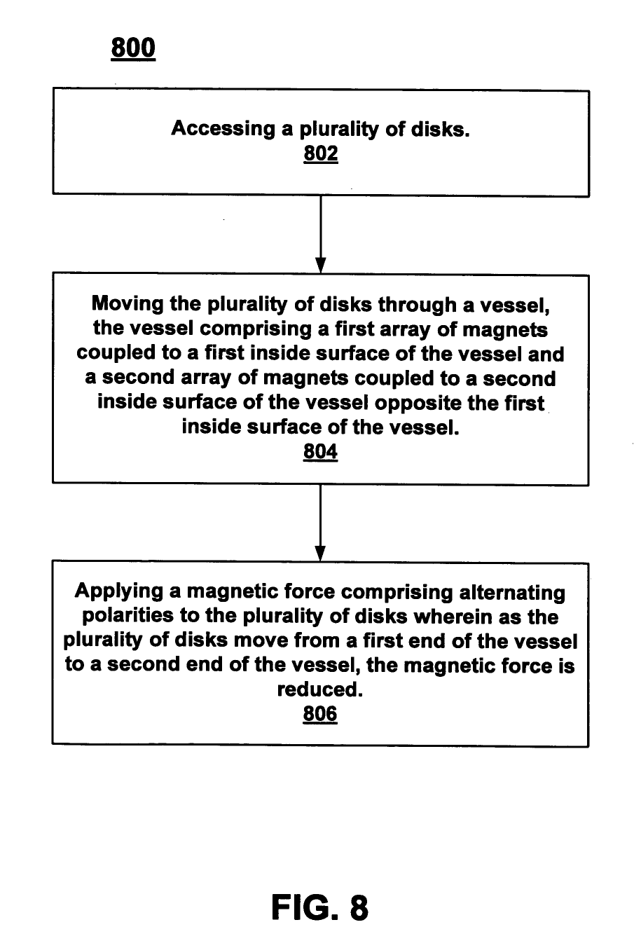

FIG. 8 is a flowchart of a method 800 for magnetically conditioning a cartridge comprising a plurality of disks in accordance with one embodiment of the present invention. At step 802, method 800 includes accessing a plurality of disks. In one embodiment of the invention, the plurality of disks is in a disk cartridge.

At step 804, method 800 includes moving the plurality of disks through a vessel, the vessel comprising a first array of magnets coupled to a first inside surface of the vessel and a second array of magnets coupled to a second inside surface of the vessel opposite the first inside surface of the vessel.

At step 806, method 800 includes applying a magnetic force comprising alternating polarities to the plurality of disks wherein as the plurality of disks move from a first end of the vessel to a second end of the vessel, the magnetic force is reduced. In one embodiment of the invention, by alternating magnetic forces on the disk and by reducing the force as the disks move through the conditioner, a zero-remanance state is achieved and the magnetism of the grains of the disk is randomized.

Embodiments of the present invention, a system and method for conditioning disk drives using a magnetic tunnel have been described. While the present invention has been described in particular embodiments, it should be appreciated that the present invention should not be construed as limited by such embodiments, but rather construed according to the following Claims.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A magnetic disk conditioner comprising:
a tunnel comprising a top inside surface and a bottom inside surface;
a first array of magnets of alternating polarity coupled to said top inside surface, said first array of magnets comprising a first portion of reduced field strength; and
a second array of magnets of alternating polarity coupled to said bottom inside surface, said second array of magnets comprising a second portion of reduced field strength and separated from said first array of magnets by a distance that allows a plurality of disks to simultaneously pass through said tunnel for conditioning.

2. The magnetic disk conditioner as described in claim 1 wherein said first array of magnets comprises larger magnets at a first end and smaller magnets at a second end, said second end comprising said first portion of reduced field strength.

3. The magnetic disk conditioner as described in claim 1 wherein said second array of magnets comprises larger magnets at a first end and smaller magnets at a second end, said second end comprising said second portion of reduced field strength.

4. The magnetic disk conditioner as described in claim 1 wherein at least one of said magnets is an electromagnet.

5. The magnetic disk conditioner as described in claim 1 wherein one magnet of said first array of magnets is a first polarity type and is coincident with one magnet of said first polarity type of said second array of magnets.

6. The magnetic disk conditioner as described in claim 1 wherein one magnet of said first array of magnets is a first polarity type and is offset from one magnet of said first polarity type of said second array of magnets.

7. The magnetic disk conditioner as described in claim 1 wherein said first array of magnets comprises similar magnetic characteristics of said second array of magnets.

8. A method for magnetically conditioning a plurality of disks comprising:
accessing a magnetic disk conditioner comprising:
a tunnel comprising a top inside surface, a bottom inside surface, a first end and a second end;
a first array of magnets of alternating polarity coupled to said top inside surface, said first array of magnets comprising a first portion of reduced field strength at said second end of said tunnel; and
a second array of magnets of alternating polarity coupled to said bottom inside surface, said second array of magnets comprising a second portion of reduced field strength at said second end of said tunnel; and
passing simultaneously a plurality of disk drive disks through said tunnel from said first end of said tunnel to said second end of said tunnel.

9. The method as described in claim 8 wherein said first array of magnets comprises larger magnets at said first end of said tunnel and smaller magnets at said second end of said tunnel.

10. The method as described in claim 8 wherein said second array of magnets comprises larger magnets at said first end of said tunnel and smaller magnets at a second end of said tunnel.

11. The method as described in claim 8 wherein at least one of said magnets is an electromagnet.

12. The method as described in claim 8 wherein one magnet of said first array of magnets is a first polarity type and is coincident with one magnet of said first polarity type of said second array of magnets.

13. The method as described in claim 8 wherein one magnet of said first array of magnets is a first polarity type and is offset from one magnet of said first polarity type of said second array of magnets.

14. The method as described in claim 8 wherein said first array of magnets comprises similar magnetic characteristics of said second array of magnets.

15. A method for magnetically conditioning a cartridge comprising a plurality of disks comprising:
accessing a plurality of disks;
moving said plurality of disks through a vessel, said vessel comprising a first array of magnets coupled to a first inside surface of said vessel and a second array of magnets coupled to a second inside surface of said vessel opposite said first inside surface of said vessel;
applying a magnetic force comprising alternating polarities to said plurality of disks wherein as said plurality of disks move from a first end of said vessel to a second end of said vessel, said magnetic force is reduced.

16. The method as described in claim 15 wherein said first array of magnets comprises larger magnets at said first end of said vessel and smaller magnets at said second end of said vessel.

17. The method as described in claim 15 wherein said second array of magnets comprises larger magnets at said first end of said vessel and smaller magnets at said second end of said vessel.

18. The method as described in claim 15 wherein at least one of said magnets is an electromagnet.

19. The method as described in claim 15 wherein one magnet of said first array of magnets is a first polarity type and is coincident with one magnet of said first polarity type of said second array of magnets.

20. The method as described in claim 15 wherein one magnet of said first array of magnets is a first polarity type and is offset from one magnet of said first polarity type of said second array of magnets.

21. The method as described in claim 15 wherein said first array of magnets comprises similar magnetic characteristics of said second array of magnets.
